(19) United States
(12) Patent Application Publication
(10) Pub. No.: US 2026/0116594 A1
(43) Pub. Date: Apr. 30, 2026

(54) APPARATUS FOR HEIGHT DIMENSIONING OF BOXES

(71) Applicant: SYSTEM CERAMICS S.p.A., Fiorano Modenese (IT)

(72) Inventors: Marco SALVÀ, Fiorano Modenese (IT); Marco MASINI, Fiorano Modenese (IT)

(21) Appl. No.: 19/373,290

(22) Filed: Oct. 29, 2025

(30) Foreign Application Priority Data
Oct. 30, 2024 (IT) 102024000024324

(51) Int. Cl. B65B 7/20; B65B 59/00

(52) U.S. Cl. CPC B65B 7/20; B65B 59/001; B65B 2210/04

(57) ABSTRACT

An apparatus for height dimensioning of boxes includes a support base to receive and support a box, a plurality of cutting blades moving closer to and away from the support base to make cuts on vertical corners of the box, a plurality of creasing devices switchable between a rest condition and a creasing condition to create creases in the horizontal direction on the box, a plurality of holding devices movable between an open condition and a closed condition to contact and restrain respective portions of the box, wherein each holding device comprises at least one respective cutting blade. When the plurality of creasing devices is in the creasing condition, the holding devices are in the restraining condition and the plurality of creasing devices is movable along creasing directions relative to the holding devices.

### TECHNICAL FIELD

The present invention relates to an apparatus for height dimensioning of boxes.

The present invention finds a preferred application in the commercial sector where a box made of paper material is used to contain one or more articles, for example for the sale and/or shipment of the article.

### BACKGROUND

In this sector, it is appropriate to use boxes that have an adequate volume for the article or articles that must be inserted in the boxes. It is therefore preferable to use boxes of different dimensions depending on the specific articles that must be contained in the boxes.

### SUMMARY

In the Applicant's experience, it is not always possible, in automated processes for packaging articles for sale and/or shipment, to have a range of box dimensions that is always and in any case capable of minimizing the volume of the box according to the actual article or the actual articles that must be inserted in the box.

In the Applicant's experience, however, it is possible to size each time, in automated processes for making boxes and packaging articles, a box according to the specific article or articles that must be contained in that box.

In the Applicant's experience it is in particular possible, starting from a relatively limited number of types of boxes that are distinguished from each other by their dimensions, to choose each time the type of box that best minimises the dimensions of the box according to the specific article or articles that must be inserted in the box and, subsequently, to adjust the height of the box with a process for height dimensioning, so that the height of the box is configured to minimise its internal volume.

This process for height dimensioning can be actuated by vertically engraving the vertical corners of the box so as to reduce the height of the side walls of the box once the cover flaps are folded in for closure. These cover flaps are in fact defined by the portions of side walls affected by the vertical incisions of the vertical corners of the box. The more extensive the vertical incisions are, the more extensive the cover flaps are and the less extensive the height of the resulting side walls are.

To facilitate the subsequent closing operations of the cover flaps of the box, which can be performed by superimposing these cover flaps on each other, the Applicant considers that the process for height dimensioning must also provide for the creation of horizontal creasing lines along the side walls of the box suitable for creating hinge lines along which to fold the cover flaps.

The Applicant has verified that it is for example possible to implement such a process for height dimensioning of the box by lowering cutting blades at the vertical corners of the box and by making cuts up to a predetermined depth in the vertical corners of the box and, subsequently or simultaneously, activating creasing devices that provide for creating horizontal creases along the side walls of the box.

The Applicant has verified that as the speed of execution of the operations for the vertical cutting of the vertical corners of the box and for creasing increases, the rate of production of vertically dimensioned boxes increases, with obvious advantages in terms of production capacity.

The Applicant has however noted that an increase in the speed of execution of the operations for the vertical cutting of the vertical corners of the box and for creasing can sometimes result in a decrease in speed in the subsequent folding operation of the cover flaps.

The Applicant has in fact noted that an increase in the speed of execution of the creasing operations can sometimes lead to a decrease in the precision of the creasing operations with the consequent formation of not perfectly horizontal or not perfectly straight creasing lines that cause difficulties in the subsequent folding operations of the cover flaps.

The Applicant has observed that in order to create the horizontal creases, the creasing devices slide horizontally along the side walls of the box and apply a force on the side walls of the box directed perpendicularly to the side walls of the box, so as to locally crush the material with which the box is made defining the wished creasing lines which make the hinge lines that facilitate the folding of the cover layers.

The Applicant has observed that as the sliding speed of the creasing devices along the side walls of the box increases, which is necessary to increase the speed of the creasing operation, the box tends to move with possible misalignments between the creasing devices and the box, leading to a decrease in the precision of the creasing operations.

The Applicant has perceived that, if the creasing operation were carried out by limiting as much as possible any movements of the box, it would be possible to increase the speed of the creasing operation without jeopardising the precision of the creasing lines created.

The Applicant has therefore found that by restraining the box with appropriate holding devices during the creasing operations, precise creasing lines can be obtained and the speed of execution of such creasing lines can be increased without jeopardising the precision of execution of the subsequent folding operations of the cover flaps.

The present invention therefore relates to an apparatus for height dimensioning of boxes.

Preferably, there is provided a support base configured to receive and support a box.

Preferably, there is provided a plurality of cutting blades configured to make cuts in the vertical direction on vertical corners of a box.

Preferably, the plurality of cutting blades and the support base are placed in an approaching and moving-away relationship.

Preferably, there is provided a plurality of creasing devices switchable between a rest condition and a creasing condition, wherein in the creasing condition said plurality of creasing devices are configured to create creases in the horizontal direction on the box.

Preferably, there is provided a plurality of holding devices movable between an open condition and a closed condition, wherein in the closed condition the holding devices are configured to contact and restrain respective portions of the box.

Preferably, each holding device of said plurality of holding devices comprises at least one respective cutting blade of said plurality of cutting blades.

Preferably, when said plurality of creasing devices is in the creasing condition, said holding devices are in the restraining condition and said plurality of creasing devices is movable along respective creasing directions relative to said holding devices.

The Applicant considers that by making the creasing devices movable relative to the holding devices when the creasing devices are in the creasing condition, the holding devices can restrain the box at holding portions of the box while the creasing devices create horizontal creases on the box. In this way, the forces that the creasing devices transmit to the box during the creasing operations can be counteracted by the holding devices avoiding unwanted displacements of the box and allowing precise and fast creases. In addition, at least part of the structure of the holding members can be used to support the cutting blades, simplifying the construction complexity of the apparatus.

The expression “vertical” or “vertically” means a direction substantially perpendicular to a bottom wall of a box. This bottom wall lies on a plane that is substantially coincident with the support base of the apparatus. Thus, a vertical direction is a direction substantially perpendicular to the support base of the apparatus.

By the expression “horizontal” or “horizontally” is meant a direction perpendicular to a vertical direction.

By the expression “height” when referred to a box, is meant a dimension of the box measured vertically between a base wall and one or more walls or cover panels when the box is in a closed condition.

By the expression “vertical corners of a box” are meant the vertical portions, or vertical lines, of a box in which two walls or side panels of the box meet.

By the expression “crease” is meant a portion, usually a line, of weakness of a box made for example by a local yielding in the material with which the box is made. A crease can for example serve to define a line of weakness that acts as a hinge line along which a panel can be folded.

By the expression “paper material” is meant a material based on paper or paper pulp in the form of individual sheets or panels or sheets or panels that are superimposed on one another or interspersed with one or more corrugated sheets in which the weight to surface ratio (grammage) is between about 80 grams per square meter and about 1000 grams per square meter.

The present invention may have at least one of the preferred features described below. These features may therefore be present individually or in combination with each other, except when expressly stated otherwise.

It is disclosed a method for dimensioning the height of a box.

Preferably, it is provided for arranging a plurality of cutting blades and a box in a vertical approaching relationship.

Preferably, it is provided for arranging a plurality of holding devices each comprising a cutting blade of said plurality of cutting blades.

Preferably, it is provided for making cuts in the vertical direction on vertical corners of a box by means of said plurality of cutting blades.

Preferably, it is provided for closing a plurality of holding devices on holding portions of the box and restraining the box at said holding portions by means of said holding devices.

Preferably, it is provided for creating creases in horizontal directions on the box at least on portions different from said holding portions while the box is restrained at said holding portions by said holding devices.

Preferably, said box is made of paper material.

Preferably, it is provided for arranging a box on the support base.

Preferably, it is provided for inserting one or more articles into the box.

Preferably, inserting one or more articles into the box is performed prior to arranging the box on the support base.

Preferably, it is provided for detecting a maximum dimension in the vertical direction of the article or articles inserted in the box.

Preferably, there is provided a detection device configured to detect a maximum dimension in the vertical direction of the article or articles inserted in the box.

Preferably, it is provided for determining a target height of the box according to the maximum dimension in the vertical direction of the article or articles inserted in the box.

Preferably, there is provided a control unit configured to determine a target height of the box according to the maximum dimension in the vertical direction of the article or articles inserted in the box.

Preferably, it is provided for determining a cutting length to be performed in the vertical direction on vertical corners of a box.

Preferably, said control unit is further configured to determine a cutting length to be performed in the vertical direction on vertical corners of a box.

Preferably, said cutting length is determined according to the target height of the box.

Preferably, the support base is vertically movable closer to and away from the plurality of cutting blades.

Preferably, making cuts in the vertical direction on vertical corners of the box is actuated by vertically moving the support base closer to the plurality of cutting blades.

Preferably, during the vertical movement of the support base closer to the plurality of cutting blades, said creasing devices are in the rest condition.

Preferably, during the vertical movement of the support base closer to the plurality of cutting blades, said holding devices are in the open condition.

Preferably, in the open condition the holding devices do not restrain respective portions of the box.

Preferably, each cutting blade is configured to make cuts in the vertical direction on vertical corners of a box when the respective holding device is in the open condition.

Preferably, making cuts in the vertical direction on vertical corners of the box is completed by stopping the vertical movement of the support base towards the plurality of cutting blades.

Preferably, making cuts in the vertical direction on vertical corners of the box is actuated prior to closing a plurality of holding devices on holding portions of the box.

Preferably, closing a plurality of holding devices on holding portions of the box is actuated after completing the operation of making cuts in the vertical direction on vertical corners of the box.

The Applicant has perceived that making vertical cuts on the vertical corners of the box does not tend to cause unwanted displacements of significant extent of the box, since making vertical cuts transmits to the box mainly vertically directed forces that are counteracted by the fact that the box is resting on the support base.

The Applicant has therefore found that it is possible to restrain the box only after making the vertical cuts on the vertical corners of the box.

Preferably, it is provided for restraining the box at said holding portions only after completing the vertical cuts on the vertical corners of the box.

Preferably, it is provided for switching the holding devices into the closed condition when the support base and the cutting blades are in the stationary position.

Preferably, the stationary position between the support base and the cutting blades is defined by a condition in which the support base and the cutting blades are not moving vertically relative to each other.

Preferably, said holding portions of the box are vertical corners of the box.

The Applicant has verified that in this way the box is restrained in portions that typically have greater structural rigidity.

Preferably, said holding portions of the box are placed in vertical elevation relative to a bottom wall of the box.

Preferably, when the holding devices are in a closed condition, the holding devices contact and restrain the box in holding positions placed in elevation relative to the support base.

Preferably, when the holding devices are in a closed condition, the holding devices contact and restrain the box in holding positions placed in elevation relative to a base wall of the box.

The Applicant has found that by restraining the box in this way, the holding devices better counteract any unwanted movements of the box than in the case where the holding devices restrain the box at the bottom wall of the box.

Preferably, said holding devices comprise respective gripping elements configured to contact and restrain respective portions of the box.

Preferably, the holding devices contact and restrain the respective portions of the box only through said gripping elements.

Preferably, when the holding devices are in the open condition the gripping elements are not in contact with the box.

Preferably, when the holding devices are in the closed condition the gripping elements are in contact with the box.

Preferably, said creasing devices comprise respective creasing heads configured to make horizontal creasing lines on said box.

Preferably, when the holding devices are in the closed condition and the plurality of creasing devices are in the creasing condition, said creasing heads are placed at a first distance from said support base.

Preferably, said first distance is measured along a vertical direction.

Preferably, said first distance corresponds to the height that the box must have.

Preferably, said first distance corresponds to said target height determined by said control unit.

Preferably, when the holding devices are in the closed condition and the plurality of creasing devices are in the creasing condition, said gripping elements are placed at a second distance from said support base.

Preferably, said second distance is measured along a vertical direction.

Preferably, said second distance is between 0.5 and 1.5 times said first distance.

Preferably, said second distance is between 0.9 and 1.1 times said first distance.

Preferably, each creasing device of the plurality of creasing devices is configured to move along the respective creasing direction away from a holding device of the plurality of holding devices and closer to a further holding device of the plurality of holding devices to create a respective crease in the horizontal direction.

Preferably, when a creasing device of the plurality of creasing devices is in the creasing condition and the holding devices are in the closed condition, said creasing device moves horizontally away from a holding device of the plurality of holding devices and moves horizontally closer to a further holding device of the plurality of holding devices.

Preferably, when the holding devices are in the open condition, the creasing devices are in the rest condition.

Preferably, each creasing device of the plurality of creasing devices moves along the respective creasing direction only when the holding devices are in the closed condition.

Preferably, said gripping elements comprise creasing inserts configured to make horizontal creases, additional to the horizontal creases that can be performed by said creasing devices, when the holding devices are in the closed condition.

Preferably, performing horizontal creases on the box at least on portions different from said holding portions while the box is restrained at said holding portions by said holding devices is actuated by closing said plurality of holding devices and providing said holding devices with gripping elements comprising creasing inserts.

The Applicant has noted that when the creasing devices are in the creasing condition and the holding devices are in the closed condition, the creasing devices may not be able to crease the entire box with a continuous creasing line closed on itself.

The Applicant has found that by providing the gripping elements with creasing inserts, the gripping elements can be used both to restrain the box in the holding portions and to make creases on such holding portions that are not directly reachable by the creasing devices due to the presence of the holding devices.

Preferably, said second distance is equal to said first distance.

Preferably, the creasing inserts of the gripping elements, when the holding devices are in the closed condition, are placed at the same vertical distance from the support base at which the creasing heads of the creasing devices are placed when in the creasing condition.

Preferably, when the holding devices are in the closed condition, the creasing inserts form horizontal creases on the vertical corners of the box.

Preferably, performing horizontal creases on the box at least on portions different from said holding portions is actuated by said creasing devices after performing creases on the holding portions.

Preferably, performing horizontal creases is preceded by either mutually moving away from or approach to each other creasing devices movable along mutually parallel directions prior to creating horizontal creases on the box by means of such creasing devices.

Preferably, mutually moving away from or approach to each other creasing devices is actuated by mutually moving closer or away the creasing devices along a horizontal direction perpendicular to the horizontal creases performed by said creasing devices.

The Applicant has found that in this way it is possible to perform creases on boxes that have dimensions that are each time different from each other, not only in height but also in width and length. By “width and length” of the box are meant the two dimensions perpendicular to each other and perpendicular to the height of the box.

Preferably, there is provided a first pair of sliding guides parallel to each other, wherein each sliding guide of said first pair of sliding guides is slidably associated with at least one respective creasing device of the plurality of creasing devices to move along a respective creasing direction.

Preferably, each sliding guide of said first pair of sliding guides develops horizontally.

Preferably, there is provided a first spacer device connected to said first pair of sliding guides. Preferably, the first spacer device is active on said first pair of sliding guides. Preferably, the first spacer device is configured to move the sliding guides of said first pair of sliding guides away from and towards each other.

The first spacer device is for example configured to space the sliding guides of the first pair of sliding guides from each other to place them at a mutual distance substantially equal to a width of the box.

Preferably, it is provided for moving creasing devices away from and towards each other according to a width of a box so that said creasing devices are spaced apart from each other by a distance substantially equal to the width of the box. Preferably, there is provided a second pair of sliding guides parallel to each other and perpendicular to the first pair of sliding guides.

Preferably, each sliding guide of said second pair of sliding guides is slidably associated with at least one respective creasing device of the plurality of creasing devices for moving along a respective creasing direction.

Preferably, each sliding guide of said second pair of sliding guides develops horizontally.

Preferably, there is provided a second spacer device connected to said second pair of sliding guides. Preferably, the second spacer device is active on said second pair of sliding guides. Preferably, the second spacer device is configured to move the sliding guides of said second pair of sliding guides away from and towards each other.

The second spacer device is for example configured to space the sliding guides of the second pair of sliding guides from each other to place them at a mutual distance substantially equal to a length of the box.

Preferably, it is provided for moving creasing devices away from and towards each other according to a length of a box so that said creasing devices are spaced apart from each other by a distance substantially equal to the length of the box.

Preferably, closing a plurality of holding devices on holding portions of the box is preceded by either mutually moving away from or approach to each other the holding devices along horizontal directions.

The Applicant has found that in this way it is possible to restrain boxes that have dimensions that each time differ from each other in width and length.

Preferably, said first spacer device is further connected to, preferably active on, a first holding device of the plurality of holding devices and a second holding device of the plurality of holding devices and on a third holding device of the plurality of holding devices and a fourth holding device of the plurality of holding devices.

Preferably, said first spacer device is connected to, preferably active on, the first holding device and the second holding device and on the third holding device and the fourth holding device to mutually move the first holding device and the second holding device away from and closer to the third holding device and the fourth holding device in a manner integral with said first pair of sliding guides.

Preferably, the first holding device and the second holding device are movable in the horizontal direction integrally with a first sliding guide of the first pair of sliding guides.

Preferably, the third holding device and the fourth holding device are movable in a horizontal direction integrally with a second sliding guide of the first pair of sliding guides.

The first spacer device is for example further configured to space from each other the first holding device and the second holding device from the third holding device and the fourth holding device to place them at a mutual distance substantially equal to a width of the box.

Preferably, it is provided for moving holding devices away from and towards each other according to a width of a box so that said holding devices are spaced apart from each other by a distance substantially equal to the width of the box.

Preferably, said second spacer device is further connected to, preferably active on, the first holding device and the third holding device and on the second holding device and the fourth holding device.

Preferably, said second spacer device is connected to, preferably active on, the first holding device and the third holding device and on the second holding device and the fourth holding device to mutually move the first holding device and the third holding device away from and towards the second holding device and the fourth holding device in a manner integral with said second pair of sliding guides.

Preferably, the first holding device and the third holding device are movable in a horizontal direction integrally with a first sliding guide of the second pair of sliding guides.

Preferably, the second holding device and the fourth holding device are movable in the horizontal direction integrally with a second sliding guide of the second pair of sliding guides.

The second spacer device is for example further configured to space from each other the first holding device and the third holding device from the second holding device and the fourth holding device to place them at a mutual distance substantially equal to a length of the box.

Preferably, it is provided for moving holding devices away from and towards each other according to a length of a box so that said holding devices are spaced apart from each other by a distance substantially equal to the length of the box.

Preferably, each holding device of the plurality of holding devices comprises a respective first upright and a respective second upright.

Preferably, said second upright is movable relative to the aforesaid first upright of the holding device between an approaching condition to the first upright of the holding device and a moving-away condition from the first upright of the holding device.

Preferably, the first upright is perpendicular to said support base.

Preferably, when the second upright of the holding device is in the moving-away condition the respective holding device is in the open condition and when the second upright of the holding device is in the approaching condition the respective holding device is in the closed condition.

Preferably, the first upright of the holding device is configured to be placed inside said box and the second upright of the holding device is configured to be placed outside said box.

In this way, the holding portions of the box are substantially clamped between the respective first and second uprights of the holding devices.

Preferably, closing a plurality of holding devices on holding portions of the box comprises arranging first uprights of said holding devices inside the box.

Preferably, closing a plurality of holding devices on holding portions of the box comprises arranging second uprights of said holding devices outside the box.

Preferably, closing a plurality of holding devices on holding portions of the box comprises moving said second holding device uprights closer to said first holding device uprights.

Preferably, closing a plurality of holding devices on holding portions of the box comprises arranging the second upright of each holding device of the plurality of holding devices in the approaching condition to the respective first upright.

Preferably, arranging the second upright of each holding device of the plurality of holding devices in the approaching condition to the respective first upright is actuated after making cuts in the vertical direction on vertical corners of a box.

Preferably, arranging the second upright of each holding device of the plurality of holding devices in the approaching condition to the respective first upright is actuated when the support base and the cutting blades are in the stationary position.

Preferably, the second upright of the holding device is rotatable relative to the first upright of the holding device between the moving-away condition and the approaching condition and between the approaching condition and the moving-away condition.

Preferably, each first upright of the holding devices comprises a respective gripping element.

Preferably, each second upright of the holding devices comprises a respective gripping element.

Preferably, when the second upright of the holding device is in the approaching condition to the respective first upright, the gripping element of the first upright of the holding device and the gripping element of the second upright of the holding device contact and grip a respective vertical corner of the box.

Preferably, when the second upright of the holding device is in the approaching condition to the respective first upright, the creasing inserts of the gripping elements of the first upright and of the second upright of the holding device form a horizontal crease on the vertical corner of the box.

Preferably, it is provided for arranging the plurality of cutting blades and a box in a vertical approaching relationship with the holding devices in the open condition.

Preferably, prior to this operation or at the same time as this operation, it is provided for actuating the first spacer device to place the first holding device and the second holding device at a first horizontal distance from the third holding device and the fourth holding device.

Preferably, said first horizontal distance is smaller than the width of the box.

Preferably, placing the first holding device and the second holding device at a first horizontal distance from the third holding device and the fourth holding device comprises moving the first holding device and the second holding device away from or towards the third holding device and the fourth holding device so that the first uprights of the holding devices can be inserted into the box without the respective gripping elements and the respective creasing inserts contacting the box.

At the same time as arranging the plurality of cutting blades and the box in a vertical approaching relationship, it is provided for inserting the first uprights of the holding device inside the box and arranging the second uprights of the holding device outside the box.

After arranging the plurality of cutting blades in a vertical approaching relationship and the box with the holding devices in the open condition, it is preferably provided to place the support base and the cutting blades in a stationary position.

When the support base and the cutting blades are in a stationary position, it is provided for actuating the first spacer device to place the first holding device and the second holding device at a second horizontal distance from the third holding device and the fourth holding device.

Preferably, said second horizontal distance is substantially equal to the width of the box.

Preferably, placing the first holding device and the second holding device at a second horizontal distance from the third holding device and the fourth holding device comprises moving the first holding device and the second holding device away from the third holding device and the fourth holding device such that the gripping elements and the respective creasing inserts of the first uprights of the holding devices contact the box.

This operation is preferably carried out at the same time as switching the holding devices into the closed condition.

Preferably, at the same time as actuating the first spacer device to place the first holding device and the second holding device at a first horizontal distance from the third holding device and the fourth holding device, it is provided for actuating the second spacer device to place the first holding device and the third holding device at a third horizontal distance from the second holding device and the fourth holding device.

Preferably, said third horizontal distance is smaller than the length of the box.

Preferably, placing the first holding device and the third holding device at a third horizontal distance from the second holding device and the fourth holding device comprises moving the first holding device and the third holding device away from the second holding device and the fourth holding device so that the first uprights of the holding devices can be inserted into the box without the respective gripping elements and the respective creasing inserts contacting the box.

At the same time as actuating the first spacer device to place the first holding device and the second holding device at a second horizontal distance from the third holding device and the fourth holding device, it is provided for actuating the second spacer device to place the first holding device and the third holding device at a fourth horizontal distance from the second holding device and the fourth holding device.

Preferably, said fourth horizontal distance is substantially equal to the length of the box.

Preferably, placing the first holding device and the third holding device at a fourth horizontal distance from the second holding device and the fourth holding device comprises moving the first holding device and the third holding device away from the second holding device and the fourth holding device so that the gripping elements and the respective creasing inserts of the first uprights of the holding devices contact the box.

This operation is preferably carried out at the same time as switching the holding devices into the closed condition.

Preferably, each first upright of the holding devices comprises a respective cutting blade.

Preferably, making cuts in the vertical direction on vertical corners of the box comprises arranging cutting blades on said first uprights of the holding devices and arranging in a vertically approaching relationship said first uprights of the holding devices and said box while said second uprights of the holding devices are moved away from said first uprights of the holding devices.

Preferably, making cuts in the vertical direction on vertical corners of the box is actuated with the first holding device and the second holding device at said first horizontal distance from the third holding device and the fourth holding device.

Preferably, making cuts in the vertical direction on vertical corners of the box is actuated with the first holding device and the third holding device at a third horizontal distance from the second holding device and the fourth holding device.

Preferably, placing the first holding device and the second holding device at a second horizontal distance from the third holding device and the fourth holding device is actuated after making cuts in the vertical direction on vertical corners of the box.

Preferably, placing the first holding device and the third holding device at a fourth horizontal distance from the second holding device and the fourth holding device is actuated after making cuts in the vertical direction on vertical corners of the box.

Preferably, each creasing device of the plurality of creasing devices comprises a respective first upright perpendicular to said support base and a respective second upright movable relative to the first upright of the creasing device between an approaching condition to the first upright of the creasing device and a moving-away condition from the first upright of the creasing device.

Preferably, when the second upright of the creasing device is in the moving-away condition the respective creasing device of the plurality of creasing devices is in the rest condition and when the second upright of the creasing device is in the approaching condition the respective creasing device of the plurality of creasing devices is in the creasing condition.

Preferably, the first upright of the creasing device is configured to be placed inside said box and the second upright of the creasing device is configured to be placed outside said box.

In this way, the box is creased by the respective first and second upright of the creasing devices.

Preferably, placing the creasing devices in the creasing condition comprises arranging first uprights of said creasing devices inside the box.

Preferably, placing the creasing devices in the creasing condition comprises arranging second uprights of said creasing devices outside the box.

Preferably, placing the creasing devices in the creasing condition comprises moving said second uprights of the creasing devices closer to said first uprights of the creasing devices.

Preferably, placing the creasing devices in the creasing condition comprises arranging the second upright of each creasing device of the plurality of creasing devices in the approaching condition to the respective first upright.

Preferably, arranging the second upright of each creasing device of the plurality of creasing devices in the approaching condition to the respective first upright is actuated after making cuts in the vertical direction on vertical corners of a box.

Preferably, arranging the second upright of each creasing device of the plurality of creasing devices in the approaching condition to the respective first upright is actuated when the support base and the cutting blades are in a stationary position.

Preferably, the second upright of the creasing device is rotatable relative to the first upright of the creasing device between the moving-away condition and the approaching condition and between the approaching condition and the moving-away condition.

Preferably, each first upright of the creasing devices comprises a respective creasing head.

Preferably, each second upright of the creasing devices comprises a respective creasing head.

Preferably, when the second upright of the creasing device is in the approaching condition to the respective first upright, the creasing head of the first upright of the creasing device and the creasing head of the second upright of the creasing device contact said box.

Preferably, it is provided for arranging the plurality of cutting blades in a vertical approaching relationship and the box with the creasing devices in the open condition.

Preferably, prior to this operation or at the same time as this operation, it is provided for actuating the first spacer device to place the creasing devices that slide along the sliding guides of the first pair of sliding guides at a first mutual sliding distance.

Preferably, said first sliding distance is smaller than the width of the box.

Preferably, placing the creasing devices that slide along the sliding guides of the first pair of sliding guides at a first mutual sliding distance comprises moving the sliding guides of the first pair of sliding guides away from or closer to each other so that the first uprights of the respective creasing devices can be inserted into the box without the respective creasing heads contacting the box.

At the same time as arranging the plurality of cutting blades and the box in a vertical approach relationship, it is provided for inserting the first uprights of the creasing devices inside the box and arranging the second uprights of the creasing devices outside the box.

After arranging the plurality of cutting blades and the box with the creasing devices in the rest condition in a vertical approaching relationship, it is preferably provided for placing the support base and the cutting blades in a stationary position.

When the support base and the cutting blades are in a stationary position, it is preferably provided for actuating the first spacer device to place the creasing devices that slide along the sliding guides of the first pair of sliding guides at a second mutual sliding distance.

Preferably, said second sliding distance is substantially equal to the width of the box.

Preferably, placing the creasing devices that slide along the sliding guides of the first pair of sliding guides at a second mutual sliding distance comprises moving the sliding guides of the first pair of sliding guides away so that the creasing heads of the first uprights of the respective creasing devices contact the box.

This operation is preferably carried out at the same time as switching the creasing devices into the creasing condition.

Preferably, at the same time as actuating the first spacer device to place the creasing devices that slide along the sliding guides of the first pair of sliding guides at a first mutual sliding distance, it is provided for actuating the second spacer device to place the creasing devices that slide along the sliding guides of the second pair of sliding guides at a third mutual sliding distance.

Preferably, said third sliding distance is smaller than the length of the box.

Preferably, placing the creasing devices that slide along the sliding guides of the second pair of sliding guides at a third mutual sliding distance comprises moving the sliding guides of the second pair of sliding guides away from or closer to each other so that the first uprights of the respective creasing devices can be inserted into the box without the respective creasing heads contacting the box.

At the same time as actuating the first spacer device to place the creasing devices that slide along the sliding guides of the first pair of sliding guides at a second mutual sliding distance, it is provided for actuating the second spacer device to place the creasing devices that slide along the sliding guides of the second pair of sliding guides at a fourth mutual sliding distance.

Preferably, said fourth sliding distance is substantially equal to the length of the box.

Preferably, placing the creasing devices that slide along the sliding guides of the second pair of sliding guides at a fourth mutual sliding distance comprises moving the sliding guides of the second pair of sliding guides away so that the creasing heads of the first uprights of the respective creasing devices contact the box.

This operation is preferably carried out at the same time as switching the creasing devices into the creasing condition.

Some operations of the method described above may be independent of the order of execution reported, unless a sequence or contemporaneity between two or more operations is expressly indicated as necessary. In addition, some operations may be optional. In addition, some operations may be performed repetitively, or may be performed in series or in parallel with other operations of the method.

### BRIEF DESCRIPTION OF THE DRAWINGS

Additional features and advantages of the present invention will be better apparent from the following detailed description of a preferred embodiment thereof, with reference to the appended drawings and provided by way of indicative and non-limiting example, wherein:
FIG. 1 is a schematic side view of an apparatus for height dimensioning of boxes in accordance with the present invention;
FIG. 2 is a schematic top view of the apparatus of FIG. 1;
FIG. 3 is a schematic perspective view of a first component of the apparatus of FIG. 1;
FIG. 4 is a schematic perspective view of a second component of the apparatus of FIG. 1;
FIGS. 5 to 16 are schematic views of the apparatus of FIG. 1 in different operating conditions;
FIG. 17 is a schematic representation of some components of the apparatus of FIG. 1; and
FIG. 18 is a top view of the apparatus of FIG. 1 with some parts removed to better highlight others.

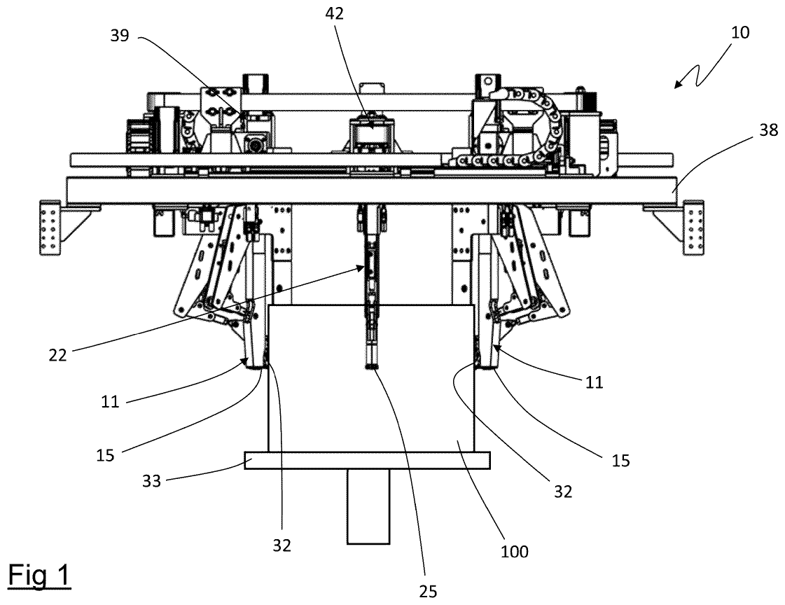

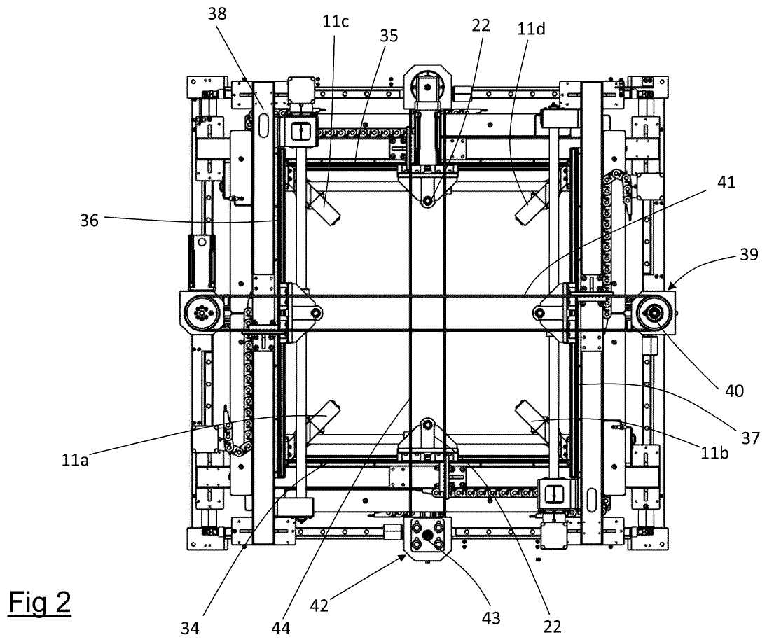

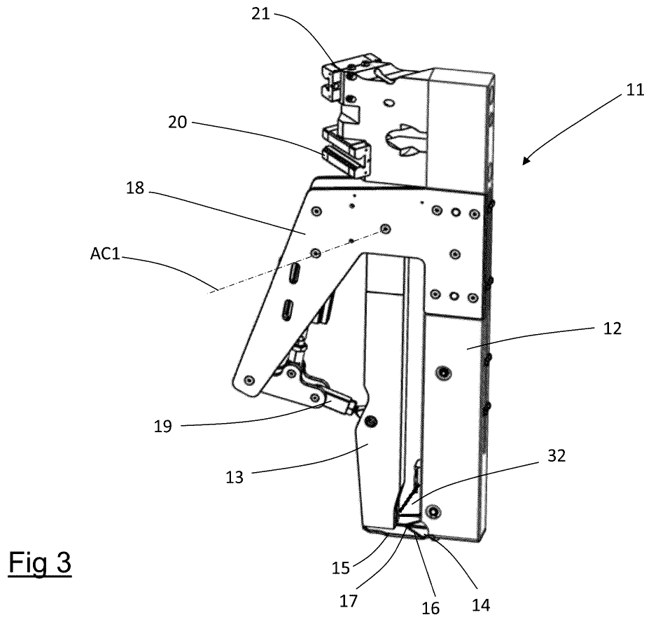

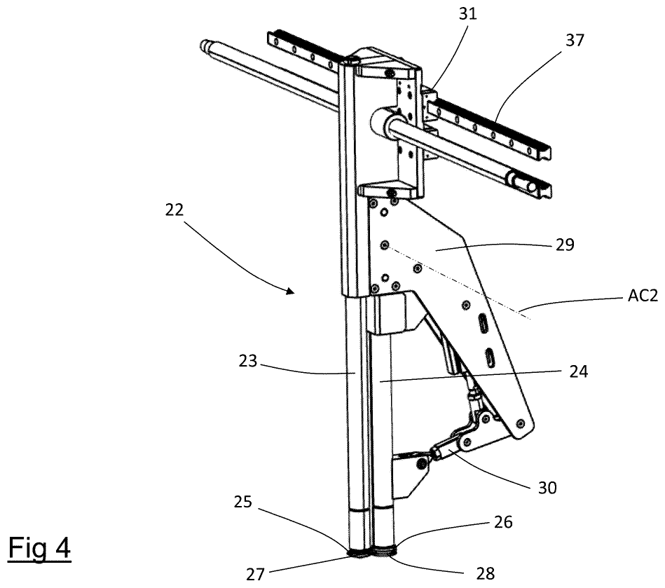

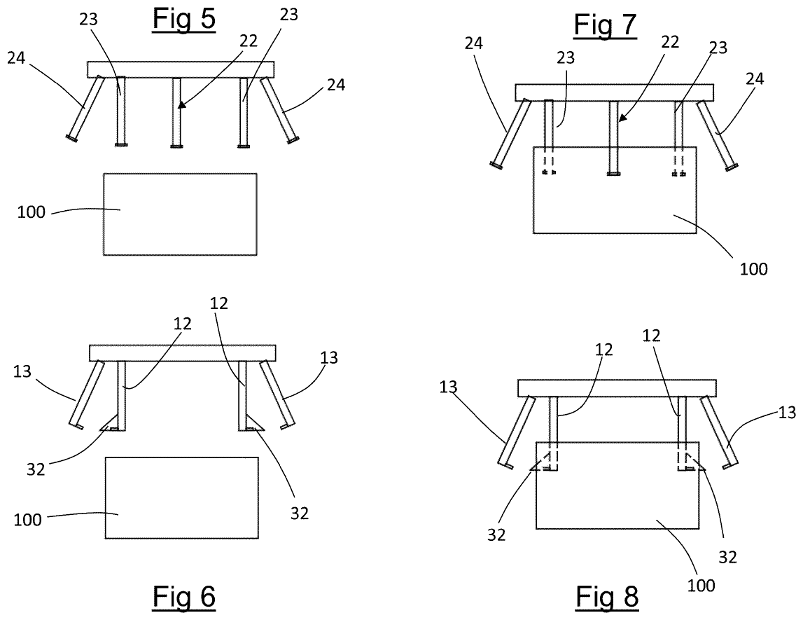

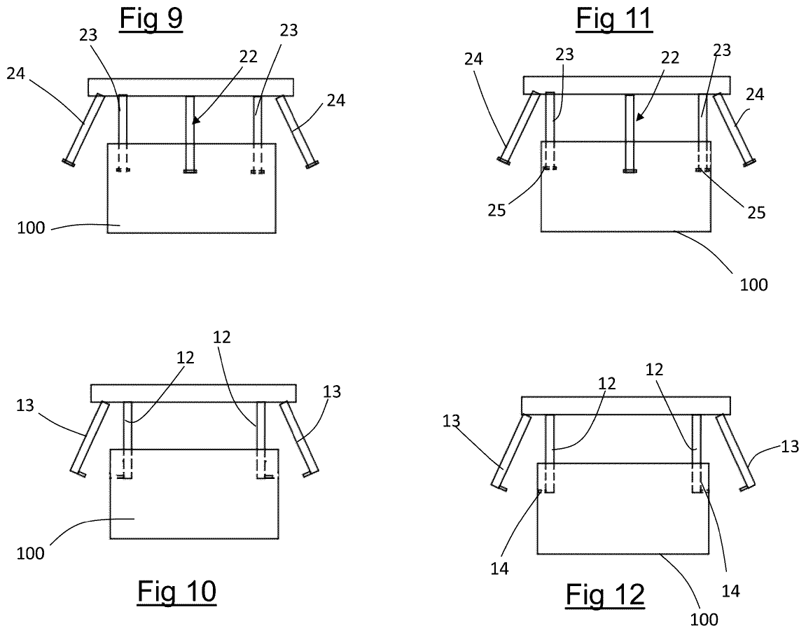

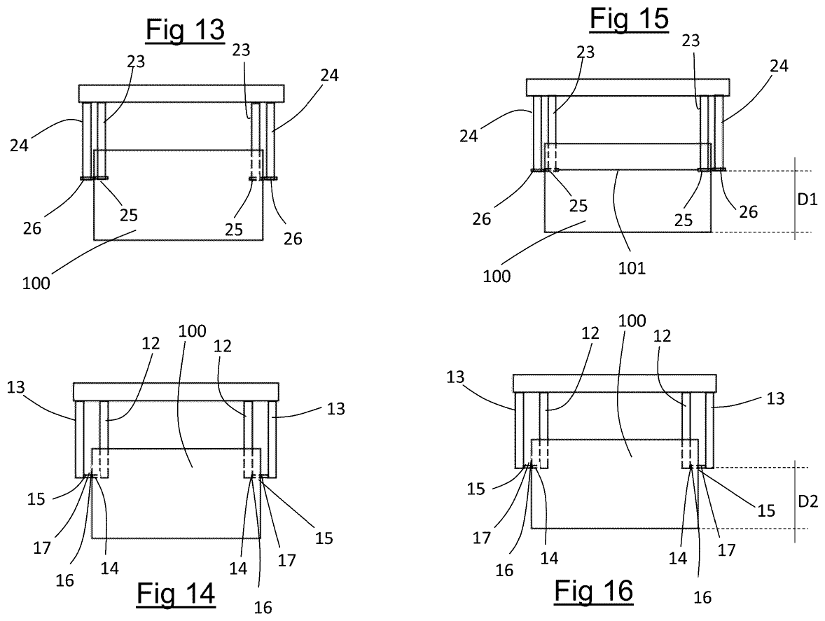

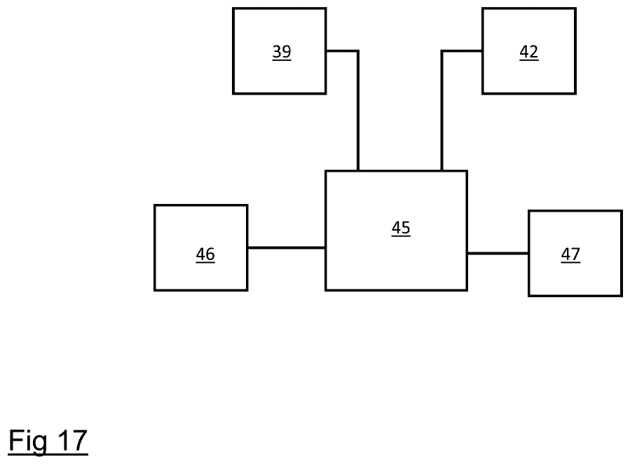

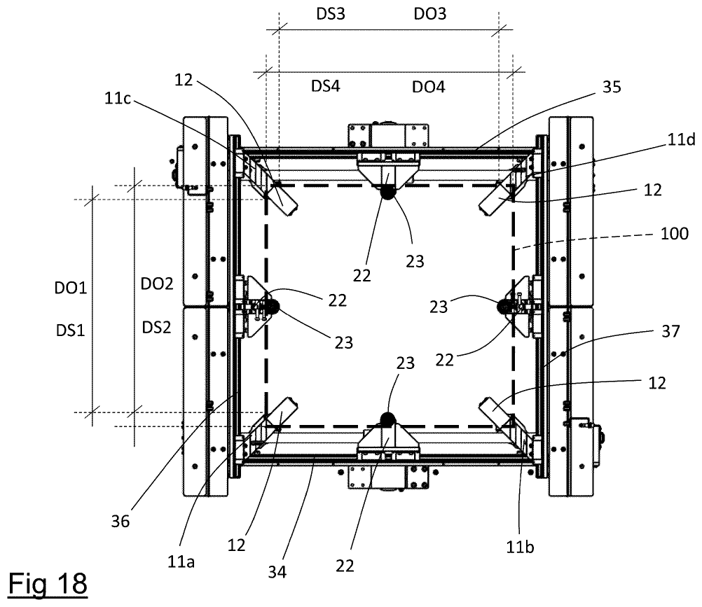

### DETAILED DESCRIPTION

In the accompanying figures, an apparatus for height dimensioning of boxes in accordance with the present invention has been indicated overall with the number 10. The boxes 100 are preferably boxes made of paper material.

The apparatus 10 comprises a plurality of holding devices 11 having the function of restraining a box 100 at respective holding portions during creasing operations of the box 100.

In the preferred embodiment of the invention the apparatus 10 comprises four holding devices 11 which are positionable at respective vertical corners of the box 100. In this embodiment, the boxes that must be dimensioned in height are boxes provided with four side walls, wherein a vertical corner is defined at each junction area between two side walls.

Each holding device 11 is switchable between an open condition and a closed condition. FIG. 3 illustrates a holding device in a closed condition.

As schematically illustrated in FIG. 3, each holding device 11 comprises a respective first upright 12 and a respective second upright 13. The first upright 12 of each holding device 11 lies along a vertical direction both when the respective holding device 11 is in the closed condition and when the respective holding device 11 is in the open condition. The second upright 13 of each holding device 11 is movable relative to the respective first upright 12. In the open condition of the holding device 11 the respective second upright 13 is moved away from the respective first upright 12 and in the closed condition the respective second upright 13 is moved closer to the respective first upright 12. The first upright 12 and the second upright 13 of each holding device 11 comprise respective gripping elements 14, 15 which have the function of gripping a holding portion of the box 100 when the holding device 11 is in the closed condition. The gripping elements 14, 15 are placed at respective free ends of the first upright 12 and of the second upright 13 of each holding device 11, as schematized in FIG. 3. The gripping elements 14, 15 are made of respective horizontally developed plates. The gripping elements 14, 15 integrate creasing inserts 16, 17. The creasing inserts 16, 17 have the function of making creases at the gripping portions of the box 100 on which the gripping elements 14, 15 act. The creasing inserts 16, 17 are made at free ends of the gripping elements 14, 15 which are directly facing each other when the holding device 11 is in the closed condition. The creasing insert 16 of the first upright 12 of each holding device 11 is substantially arrowhead-shaped with two free edges forming an angle of about 90° between them. The creasing insert 17 of the second upright 13 of each holding device 11 is substantially counter-shaped to the creasing insert 16 of the respective first upright 12. The creasing insert 17 of the second upright 13 of each holding device 11 has two free edges forming an angle of about 90° between them defining a recess that receives the creasing insert 16 of the respective first upright 12.

To make the second upright 13 of the holding device 11 movable relative to the respective first upright 12, this second upright 13 is rotatable relative to the respective first upright 12. The second upright 13 of the holding device 11 rotates relative to the respective first upright 12 about a hinge axis AC1 distal from the respective gripping element 15. For this purpose, the holding device 11 comprises a mounting structure 18 to which the respective first upright 12 is rigidly fixed and to which the respective second upright 13 is rotatably connected at the hinge axis AC1. An actuator 19 is also connected to the mounting structure 18 and which acts on the second upright 13 of the holding device 11 in a position located between the gripping element 15 and the hinge axis AC1, as schematically illustrated in FIG. 3. By operating the actuator 19, the second upright 13 of the holding device 11 rotates towards and away from the respective first upright 12. When the second upright 13 of the holding device 11 is moving away from the first upright 12, the gripping elements 14, 15 are spaced apart from each other and when the second upright 13 of the holding device 11 is moving towards the respective first upright 12, the gripping elements 14, 15 are substantially in contact with each other. The holding element 11 further comprises a first sliding shoe 20 and a second sliding shoe 21, the function of which will be better defined below. The first sliding shoe 20 and the second sliding shoe 21 are oriented along respective horizontal directions perpendicular to each other. The first sliding shoe 20 and the second sliding shoe 21 are placed at an end of the holding device 11 opposite to the end in which the gripping elements 14, 15 are arranged.

The apparatus 10 comprises a plurality of creasing devices 22 having the function of creating horizontal creases on the box 100. The creasing devices 22 create creases along horizontal directions on at least part of the side walls of the box 100.

FIG. 4 schematically illustrates a creasing device 22. In the preferred embodiment of the invention, the apparatus 10 comprises four creasing devices 22, one for each side wall of the box.

Each creasing device 22 is switchable between a rest condition and a creasing condition. FIG. 4 illustrates a creasing device 22 in a creasing condition.

As schematically illustrated in FIG. 4, each creasing device 22 comprises a respective first upright 23 and a respective second upright 24. The first upright 23 of each creasing device 22 lies along a vertical direction both when the creasing device 22 is in the rest condition and when the creasing device 22 is in the creasing condition. The second upright 24 of each creasing device 22 is movable relative to the respective first upright 23. In the rest condition of the creasing device 22 the respective second upright 24 is moved away from the respective first upright 23 and in the creasing condition the respective second upright 24 is moved closer to the respective first upright 23. The first upright 23 and the second upright 24 of each creasing device 22 comprise respective creasing heads 25, 26 which have the function of softening the paper material of the box 100 and then creating a crease when the creasing device 22 is in the creasing condition. The creasing heads 25, 26 are placed at respective free ends of the first upright 23 and of the second upright 24 of each creasing device 22, as schematized in FIG. 4. Each creasing head 25, 26 comprises a creasing wheel 27, 28. The creasing wheels 27, 28 are rotatable about an axis vertical to the upright of the creasing device to which they are connected. The creasing wheels are provided with respective circumferential profiles configured to interact with each other to create a crease.

To make the second upright 24 of the creasing device 22 movable relative to the respective first upright 23, the second upright 24 of the creasing device 22 is rotatable relative to the respective first upright 23. The second upright 24 of the creasing device 22 rotates relative to the respective first upright 23 about a hinge axis AC2 distal from the respective creasing head 26. For this purpose, the creasing device 22 comprises a mounting structure 29 to which the respective first upright 23 is rigidly fixed and to which the respective second upright 24 is rotatably connected at the hinge axis AC2. An actuator 30 is also connected to the mounting structure 29 and which acts on the second upright 24 of the creasing device 22 at a position located between the creasing head 26 and the hinge axis AC2, as schematically illustrated in FIG. 4. By operating the actuator 30, the second upright 24 of the creasing device 22 rotates closer to and away from the respective first upright 23. When the second upright 24 of the creasing device 22 is moving away from the respective first upright 23, the creasing heads 25, 26 are spaced apart from each other and when the second upright 24 of the creasing device 22 is moving closer to respective first upright 23, the creasing heads 25, 26 are substantially in contact with each other. The creasing device 22 further comprises a sliding shoe 31 the function of which will be better defined hereinafter. The sliding shoe 31 is oriented along a horizontal direction and is placed at an opposite end of the creasing device 22 relative to the end at which the creasing heads 25, 26 are arranged.

The apparatus 10 comprises a plurality of cutting blades 32. The cutting blades 32 are configured to make vertical cuts on the vertical corners of the box 100. Each cutting blade 32 is associated with a respective holding device 11. As schematically illustrated in FIG. 3, the first upright 12 of each holding device 11 comprises a cutting blade 32. The cutting blade 32 is placed in proximity to the gripping element 14 of the first upright 12 of each holding device 11. The cutting blade 32 can be movable between a retracted condition in which it is completely contained in the first upright 12 and an extracted condition in which it is extracted from the first upright 12 of each holding device 11. Alternatively, the cutting blade 32 may be fixed in the extracted position. In the extracted position, the cutting blade 32 extends substantially up to the gripping element 14 of the first upright 12 of each holding device 11, as schematically illustrated in FIG. 3.

As schematically illustrated in FIG. 1, the apparatus 10 comprises a support base 33 configured to receive and support a box 100. The support base 33 is vertically movable between a lowered position and a plurality of raised positions. FIG. 1 illustrates the support base 33 in a raised position.

The creasing devices 22 are movable horizontally during creasing operations. For this purpose, the apparatus 10 comprises a first pair of sliding guides 34, 35 parallel to each other and developing along a first horizontal direction. The apparatus 10 further comprises a second pair of sliding guides 36, 37 parallel to each other and developing along a second horizontal direction perpendicular to the first horizontal direction, as schematically illustrated in FIG. 2. The apparatus 10 comprises a support frame 38 placed vertically above support base 33. The support frame 38 is vertically stationary, i.e. it is not movable in the vertical direction. The first pair of sliding guides 34, 35 is connected to the support frame 38. The second pair of sliding guides 36, 37 is connected to the support frame 38.

A creasing device 22 is slidably mounted on the first sliding guide 34 of the first pair of sliding guides 34, 35 by means of the respective sliding shoe 31. A creasing device 22 is slidably mounted on the second sliding guide 35 of the first pair of sliding guides 34, 35 by means of the respective sliding shoe 31. A creasing device 22 is slidably mounted on the first sliding guide 36 of the second pair of sliding guides 36, 37 by means of the respective sliding shoe 31. A creasing device 22 is slidably mounted on the second sliding guide 37 of the second pair of sliding guides 36, 37 by means of the respective sliding shoe 31.

A first holding device 11a is slidably mounted on the first sliding guide 34 of the first pair of sliding guides 34, 35 and on the first sliding guide 36 of the second pair of sliding guides 36, 37. This mounting is actuated through the first sliding shoe 20 and the second sliding shoe 21 of the holding device 11. A second holding device 11b is slidably mounted on the first sliding guide 34 of the first pair of sliding guides 34, 35 and on the second sliding guide 37 of the second pair of sliding guides 36, 37. This mounting is actuated through the first sliding shoe 20 and the second sliding shoe 21 of the holding device 11. A third holding device 11c is slidably mounted on the second sliding guide 35 of the first pair of sliding guides 34, 35 and on the first sliding guide 36 of the second pair of sliding guides 36, 37. This mounting is actuated through the first sliding shoe 20 and the second sliding shoe 21 of the holding device 11. A fourth holding device 11d is slidably mounted on the second sliding guide 35 of the first pair of sliding guides 34, 35 and on the second sliding guide 37 of the second pair of sliding guides 36, 37. This mounting is actuated through the first sliding shoe 20 and the second sliding shoe 21 of the holding device 11.

The apparatus 10 further comprises a first spacer device 39 configured to move the first sliding guide 34 and the second sliding guide 35 of the first pair of sliding guides 34, 35 closer to and away from each other along a horizontal direction perpendicular to the horizontal direction along which said sliding guides 34, 35 develop. For this purpose, the first pair of sliding guides is slidably mounted on the support frame 38 along a horizontal direction perpendicular to the lying horizontal directions of the first pair of sliding guides 34, 35. The first spacer device 39 comprises an electric motor 40 and a transmission 41 (for example a toothed belt driven on a pulley) which are active on the first sliding guide 34 and on the second sliding guide 35 of the first pair of sliding guides 34, 35 to move the first sliding guide 34 and the second sliding guide 35 of the first pair of sliding guides 34, 35 towards and away from each other. When the first sliding guide 34 and the second sliding guide 35 of the first pair of sliding guides 34, 35 are set in movement relative to each other, the first holding device 11a and the second holding device 11b move integrally with the first sliding guide 34 of the first pair of sliding guides 34, 35 by sliding respectively on the first sliding guide 36 and on the second sliding guide 37 of the second pair of sliding guides 36, 37. Similarly, when the first sliding guide 34 and the second sliding guide 35 of the first pair of sliding guides 34, 35 are set in movement relative to each other, the third holding device 11c and the fourth holding device 11d move integrally with the second sliding guide 35 of the first pair of sliding guides 34, 35 by sliding respectively on the first sliding guide 36 and on the second sliding guide 37 of the second pair of sliding guides 36, 37. The first spacer device 39 is then further configured to mutually move the first holding device 11a and the second holding device 11b closer to the third holding device 11c and the fourth holding device 11d in the horizontal direction.

The apparatus 10 further comprises a second spacer device 42 configured to move closer to and away from each other the first sliding guide 36 and the second sliding guide 37 of the second pair of sliding guides 36, 37 along a horizontal direction perpendicular to the horizontal direction along which said sliding guides 36, 37 develop. For this purpose, the second pair of sliding guides 36, 37 is slidably mounted on the support frame 38 along a horizontal direction perpendicular to the lying horizontal directions of the second pair of sliding guides 36, 37. The second spacer device 42 comprises an electric motor 43 and a transmission 44 (for example a toothed belt driven on a pulley) which are active on the second sliding guide 36 and on the second sliding guide 37 of the second pair of sliding guides 36, 37 to move the first sliding guide 36 and the second sliding guide 37 of the second pair of sliding guides 36, 37 towards and away from each other. When the first sliding guide 36 and the second sliding guide 37 of the second pair of sliding guides 36, 37 are set in movement relative to each other, the first holding device 11a and the third holding device 11c move integrally with the first sliding guide 36 of the second pair of sliding guides 36, 37 by sliding respectively on the first sliding guide 34 and on the second sliding guide 35 of the first pair of sliding guides 34, 35. Similarly, when the first sliding guide 36 and the second sliding guide 37 of the second pair of sliding guides 36, 37 are set in movement relative to each other, the second holding device 11b and the fourth holding device 11d move integrally with the second sliding guide 37 of the second pair of sliding guides 36, 37 by sliding respectively on the first sliding guide 34 and on the second sliding guide 35 of the first pair of sliding guides 34, 35. The second spacer device 42 is then further configured to mutually move in the horizontal direction the first holding device 11a and the third holding device 11c closer to the second holding device 11b and the fourth holding device 11d.

As schematized in FIG. 17, the apparatus comprises a control unit 45 configured to determine a target height that the box 100 must have and to determine the position in the vertical direction that the horizontal creases must have on the box 100. The control unit 45 (e.g. a microprocessor) is placed in signal communication with a detection device 46 configured to detect a maximum dimension in the vertical direction of one or more articles placed in the box 100. The detection device may for example be one or more cameras, one or more cameras, one or more feelers, one or more laser distance meters. The control unit 45 is further placed in signal communication with a dimension detector 47 configured to detect a width dimension and a length dimension of the box 100. The dimension detector 47 may for example be one or more video-cameras, one or more cameras, one or more feelers, one or more laser distance meters, a user interface in which an operator inputs data identified or representative of the width and length of the box. The control unit 45 is further configured to determine a cutting length to be performed in the vertical direction on the vertical corners of the box. The control unit 45 is further configured to actuate the first spacer device 39 and the second spacer device 42 according to the detected width and length of the box.

In use and according to a possible implementation of a method for dimensioning the height of a box, a box 100 is positioned on the support base 33. The support base 33 is in the lowered position. Inside the box 100, one or more articles are previously, simultaneously or subsequently introduced, which for example must be (contained inside the box 100) for a user. The control unit 45 determines the target height that the box 100 must have and that minimizes the height of the box 100 itself according to the articles contained therein. The control unit 45 further determines the width and length of the box 100.

In this operating condition, the holding devices 11 are in the open condition, as schematically illustrated in FIG. 6. In this operating condition, the creasing devices 22 are in the rest condition, as schematically illustrated in FIG. 5.

The control unit 45 operates the first spacer device 39 to move closer or away the creasing devices 22 that slide along the sliding guides 34, 35 of the first pair of sliding guides 34, 35 at a first sliding distance DS1 corresponding to a mutual distance of the relative creasing devices 22 such that the first uprights 23 of the creasing devices 22 can be arranged inside the box 100 and the second uprights 24 of the creasing devices 22 can be arranged outside the box 100.

The activation of the first spacer device 39 to move the first pair of sliding guides 34, 35 closer or away further causes a movement of the first holding device 11a and the second holding device 11b closer to or away from the third holding device 11c and the fourth holding device 11d. The first holding device 11a and the second holding device 11b are positioned at a first horizontal distance DO1 from the third holding device 11c and the fourth holding device 11d such that the first uprights 12 of the holding devices 11 can be arranged inside the box 100 and the second uprights 13 of the holding devices 11 can be arranged outside the box 100. In a preferred embodiment, the first sliding distance DS1 coincides with the first horizontal distance DO1.

Simultaneously or subsequently, the control unit 45 operates the second spacer device 42 to move closer or away the creasing devices 22 that slide along the sliding guides 36, 37 of the second pair of sliding guides 36, 37 at a third sliding distance DS3 which corresponds to a mutual distance of the relative creasing devices 22 such that the respective first uprights 23 can be arranged inside the box 100 and the respective second uprights 24 can be arranged outside the box 100.

The activation of the second spacer device 42 to move the second pair of sliding guides 36, 37 closer or away also causes a movement of the first holding device 11a and the third holding device 11c closer to or away from the second holding device 11b and the fourth holding device 11d. The first holding device 11a and the third holding device 11c are positioned at a third horizontal distance DO3 from the second holding device 11b and the fourth holding device 11d such that the first uprights 12 of the holding devices 11 can be arranged inside the box 100 and the second uprights 13 of the holding devices 11 can be arranged outside the box 100. In a preferred embodiment, the third sliding distance DS3 coincides with the third horizontal distance DO3.

Subsequently, the support base 33 is raised vertically up to a predetermined raised position. Said predetermined raised position is determined by the control unit 45 according to the determined target height. The vertical lifting of the support base 33 results in a corresponding vertical lifting of the box 100.

During the lifting of the box 100, the first uprights 12 of the holding devices 11 and the first uprights 23 of the creasing devices 22 are inserted inside the box 100 and the second uprights 13 of the holding devices 11 and the second uprights 24 of the creasing devices 22 are arranged outside the box 100. The first sliding distance DS1 and the third sliding distance DS3 are such as to ensure that the creasing heads 25 of the first uprights 23 of the creasing devices 22 do not contact the side walls of the box. The first horizontal distance DO1 and the third horizontal distance DO3 are such as to ensure that the gripping elements 14 and the relative creasing inserts 16 of the first uprights 12 of the holding devices 11 do not contact the side walls of the box. The first horizontal distance DO1 and the third horizontal distance DO3 are also such as to ensure that the cutting blades 32 mounted on the first uprights 12 of the holding devices 11 intercept and contact the vertical corners of the box 100.

During the lifting of the box 100, the cutting blades 32 (possibly switched into the extracted position if the possibility of switching between the retracted position and the extracted position is provided) make vertical cuts on the box 100 at the vertical corners of the box, as schematically illustrated in FIG. 8. The support base 33 is placed into a stationary condition when it reaches the predetermined raised position. As schematically illustrated in FIG. 8, in this operating condition the holding devices 11 are in the open condition and the cutting blades 32 have completed the vertical cuts at the vertical corners of the box 100. As shown schematically in FIG. 7, in this operating condition the creasing devices 22 are in the rest condition.

Subsequently, the cutting blades 32 are possibly switched into the retracted position (if the possibility of switching between the retracted position and the extracted position is provided), as schematized in FIG. 10. The holding devices 11 remain in the reached configuration and the creasing devices 22 remain in the reached configuration, as schematized in FIGS. 9 and 10.

Subsequently, the control unit 45 operates the first spacer device 39 to move away the creasing devices 22 that slide along the sliding guides 34, 35 of the first pair of sliding guides 34, 35 at a second sliding distance DS2 that corresponds to a mutual distance of the relative creasing devices 22 such that the creasing heads 25 of the first uprights 23 of the creasing devices 22 contact the side walls of the box 100. This contact takes place at the inner side walls of the box 100, as schematically illustrated in FIG. 11.

The activation of the first spacer device 39 to move away the first pair of sliding guides 34, 35 further causes a movement of the first holding device 11a and the second holding device 11b away from the third holding device 11c and the fourth holding device 11d. The first holding device 11a and the second holding device 11b are positioned at a second horizontal distance DO2 from the third holding device 11c and the fourth holding device 11d such that the gripping elements 14 and the creasing inserts 16 of the first uprights 12 of the holding devices 11 come into contact with the vertical corners of the box 100. This contact takes place at the inner walls of the vertical corners of the box 100, as schematically illustrated in FIG. 12. In a preferred embodiment, the second sliding distance DS2 coincides with the second horizontal distance DO2.

Simultaneously or subsequently, the control unit 45 operates the second spacer device 42 to move away the creasing devices 22 that slide along the sliding guides 36, 37 of the second pair of sliding guides 36, 37 at a fourth sliding distance DS4 that corresponds to a mutual distance of the relative creasing devices 22 such that the creasing heads 25 of the respective first uprights 23 contact the side walls of the box 100. This contact takes place at the inner side walls of the box 100.

The activation of the second spacer device 42 to move away the second pair of sliding guides 36, 37 further causes a movement of the first holding device 11a and the third holding device 11c away from the second holding device 11b and the fourth holding device 11d. The first holding device 11a and the third holding device 11c are positioned at a fourth horizontal distance DO4 from the second holding device 11b and the fourth holding device 11d such that the gripping elements 14 and the creasing inserts 16 of the first uprights 12 of the holding devices 11 come into contact with the vertical corners of the box 100. In a preferred embodiment, the fourth sliding distance DS4 coincides with the fourth horizontal distance DO4.

Thereafter, the holding devices 11 are switched into the closed condition. The second uprights 13 of the holding devices 11 move closer to the respective first uprights 12 and the gripping elements 14, 15 of the first uprights 12 and of the second uprights 13 of the holding devices 11 are closed on the vertical corners of the box 100 restraining the box 100, as schematically illustrated in FIG. 14. The creasing inserts 16, 17 are also closed on the vertical corners of the box 100 forming horizontal creases on the vertical corners of the box 100.

Simultaneously or subsequently, the creasing devices 22 are switched into the creasing condition. The second uprights 24 of the creasing devices 22 move closer to the respective first uprights 23 and the creasing heads 25, 26 contact the side walls of the box so as to be able to soften the material of the box 100, as schematized in FIG. 13. In this operating condition, the creasing heads 25, 26 are placed at a first distance D1 measured in the vertical direction from the support base 33 and the gripping elements 14, 15 (and with them the creasing inserts 16, 17) are placed at a second distance D2 measured in the vertical direction from the support base 33. The first distance D1 is equal to the second distance D2 so that the horizontal creases that the creasing heads 25, 26 will create are placed at the same vertical distance from the support base 33 of the creases created by the creasing inserts 16, 17 on the vertical corners of the box 100.

Subsequently, the creasing devices 22 are shifted in the horizontal direction along the respective sliding guides of the first pair of sliding guides 34, 35 and of the second pair of sliding guides 36, 37, forming creases in the horizontal directions 101 along the side walls of the box 100, as schematized in FIG. 15. In this operating condition, the holding devices 11 remain stationary in the closed condition, as schematically illustrated in FIG. 16. The horizontal creases created by the creasing devices 22 reach and are joined to the creases made by the creasing inserts 16, 17 on the vertical corners of the box 100, so that the box 100 has a continuous creasing line along all the side walls.

Subsequently, the holding devices 11 are switched into the open condition and the creasing devices 22 are switched into the rest condition and the support base 33 with the box 100 provided with the creases created thereon are moved into the lowered condition. Subsequent folding operations of the cover flaps around the creasing lines performed by the apparatus 10 can be actuated to close the box with the article or articles inside.

1. An apparatus for height dimensioning of boxes, the apparatus comprising:
a support base configured to receive and support a box;
a plurality of cutting blades, wherein said plurality of cutting blades and said support base are placed in an approaching and moving-away relationship, and wherein said cutting blades are configured to make cuts in a vertical direction on vertical corners of a box;
a plurality of creasing devices switchable between a rest condition and a creasing condition, wherein in the creasing condition said plurality of creasing devices are configured to create creases in the horizontal direction on said box;
a plurality of holding devices movable between an open condition and a closed condition, wherein in the closed condition said holding devices are configured to contact and restrain respective portions of said box, and wherein each holding device of said plurality of holding devices comprises at least one respective cutting blade of said plurality of cutting blades;
wherein when said plurality of creasing devices are in the creasing condition, said holding devices are in the restraining condition and said plurality of creasing devices are movable along respective creasing directions relative to said holding devices.

2. The apparatus according to claim 1, wherein each creasing device of said plurality of creasing devices is configured to move along said respective creasing direction away from a holding device of said plurality of holding devices and closer to a further holding device of said plurality of holding devices to create a respective crease in the horizontal direction.

3. The apparatus according to claim 1, wherein each cutting blade of said plurality of cutting blades is configured to operate cuts in a vertical direction on vertical corners of a box when the respective holding device is in the open condition.

4. The apparatus according to claim 1, wherein said holding devices comprise respective gripping elements configured to contact and restrain respective portions of said box and wherein said creasing devices comprise respective creasing heads configured to make horizontal creasing lines on said box; wherein when said holding devices are in the closed condition and said plurality of creasing devices are in the creasing condition, said creasing heads are placed at a first distance from said support base and said gripping elements are placed at a second distance from said support base, wherein said first distance and said second distance are measured in the vertical direction and wherein said second distance is between 0.5 and 1.5 times said first distance.

5. The apparatus according to claim 4, wherein said gripping elements comprise creasing inserts configured to make horizontal creases, additional to the horizontal creases that can be performed by said creasing devices, wherein when said holding devices are in the closed condition, said second distance being equal to said first distance.

6. The apparatus according to claim 1, comprising a first pair of sliding guides parallel to each other, wherein each sliding guide of said first pair of sliding guides is slidably associated with at least one respective creasing device of said plurality of creasing devices to move along a respective creasing direction.

7. The apparatus according to claim 6, comprising a first spacer device connected to said first pair of sliding guides and configured to move said sliding guides of said first pair of sliding guides away from and towards each other.

8. The apparatus according to claim 7, comprising a second pair of sliding guides parallel to each other and perpendicular to said first pair of sliding guides, wherein each sliding guide of said second pair of sliding guides is slidably associated with at least one respective creasing device of said plurality of creasing devices to move along a respective creasing direction.

9. The apparatus according to claim 8, comprising a second spacer device connected to said second pair of sliding guides and configured to move said sliding guides of said second pair of sliding guides away from and towards each other.

10. The apparatus according to claim 7, wherein said first spacer device is further connected to a first holding device and a second holding device and to a third holding device and a fourth holding device to mutually move said first holding device and second holding device away from and towards said third holding device and fourth holding device in a manner integral with said first pair of sliding guides.

11. The apparatus according to claim 9, wherein said first spacer device is further connected to a first holding device and a second holding device and to a third holding device and a fourth holding device to mutually move said first holding device and second holding device away from and towards said third holding device and fourth holding device in a manner integral with said first pair of sliding guides, and wherein said second spacer device is further connected to said first holding device and third holding device and to said second holding device and fourth holding device to mutually move said first holding device and third holding device away from and closer to said second holding device and fourth holding device in a manner integral with said second pair of sliding guides.

12. The apparatus according to claim 1, wherein each holding device of said plurality of holding devices comprises a respective first upright configured to be placed inside said box and a respective second upright configured to be placed outside said box.

13. The apparatus according to claim 12, wherein said second upright of the holding device is movable relative to said first upright of the holding device between an approaching condition to said first upright of the holding device and a moving-away condition from said first upright of the holding device; wherein when said second upright of the holding device is in the moving-away condition, said holding device is in the open condition, and wherein when said second upright of the holding device is in the approaching condition, said holding device is in the closed condition.

14. The apparatus according to claim 1, wherein each creasing device of said plurality of creasing devices comprises a respective first upright perpendicular to said support base and configured to be placed inside said box and a respective second upright configured to be placed outside said box.

15. The apparatus according to claim 14, wherein said second upright of the creasing device is movable relative to said first upright of the creasing device between an approaching condition to said first upright of the creasing device and a moving-away condition from said first upright of the creasing device; wherein when said second upright of the creasing device is in the moving-away condition said creasing device is in the rest condition and wherein when said second upright of the creasing device is in the approaching condition said creasing device is in the creasing condition.
